(19) United States
(12) Patent Application Publication
(10) Pub. No.: US 2025/0347151 A1
(43) Pub. Date: Nov. 13, 2025

(54) DEADBOLT LOCK

(71) Applicant: ASSA ABLOY Access and Egress Hardware Group, Inc., New Haven, CT (US)

(72) Inventors: Rick Leites, Milford, CT (US); Joseph Martone, Bristol, CT (US); Scott Morstatt, Maryville, TN (US)

(73) Assignee: ASSA ABLOY Access and Egress Hardware Group, Inc., New Haven, CT (US)

(21) Appl. No.: 19/200,934

(22) Filed: May 7, 2025

Related U.S. Application Data
(60) Provisional application No. 63/644,326, filed on May 8, 2024.

(51) Int. Cl. E05B 49/00; E05B 63/00

(52) U.S. Cl. CPC E05B 49/00; E05B 63/0017

(57) ABSTRACT

A deadbolt lock includes a thumb turn that may be actuatable to move from a neutral position to extend/retract the deadbolt and configured to automatically move back to the neutral position while the deadbolt remains in the desired position. The thumb turn may extend below the escutcheon. An interior thumb turn may be configured to follow movement of the exterior thumb turn and remain in that position while the exterior thumb turn automatically moves back to the neutral position. The interior thumb turn thereby provides an indication that the deadbolt is in the extended position. A key cylinder having an axis of rotation may be positioned on the lock such that the axis of rotation of the key cylinder does not intersect with the deadbolt axis of movement.

### CROSS-REFERENCE TO RELATED APPLICATIONS

This application claims the benefit under 35 U.S.C. § 119(e) to U.S. Provisional Application Ser. No. 63/644,326, entitled “DEADBOLT LOCK,” filed May 8, 2024, which is incorporated herein by reference in its entirety.

### FIELD

Disclosed embodiments are related to deadbolt locks.

### BACKGROUND

Deadbolt locks are used to secure access locations, such as doors. Some deadbolt locks may be configured with a key and/or other user interface. Some deadbolt locks may be configured as battery powered electronic locks.

### SUMMARY

In some aspects, a deadbolt lock includes a deadbolt configured to extend into an extended position and configured to retract into a retracted position, and a swing thumb turn operatively coupled to the deadbolt and biased into a neutral position. The swing thumb turn is actuatable to swing from the neutral position in a first direction to extend the deadbolt and configured to automatically swing back to the neutral position while the deadbolt remains in the extended position. The swing thumb turn is also actuatable to swing from the neutral position in a second direction opposite the first direction to retract the deadbolt and configured to automatically swing back to the neutral position while the deadbolt remains in the retracted position.

In some aspects, a deadbolt lock includes an escutcheon, a deadbolt configured to extend into an extended position and configured to retract into a retracted position, and a swing thumb turn operatively coupled to the deadbolt and extending below the escutcheon. The swing thumb turn is actuatable to swing in a first direction to extend the deadbolt and actuatable to swing in a second direction opposite the first direction to retract the deadbolt.

In some aspects, a deadbolt lock includes an interior trim including an interior thumb turn and configured to be mounted on an interior side of a door, an exterior trim including an exterior swing thumb turn and configured to be mounted on an exterior side of a door, and a deadbolt operatively connected to the interior trim and the exterior trim. The deadbolt is configured to extend into an extended position and configured to retract into a retracted position. The exterior swing thumb turn operatively coupled to the deadbolt and biased into a neutral position. The exterior swing thumb turn being actuatable to swing from the neutral position in a first direction to extend the deadbolt and configured to automatically swing back to the neutral position while the deadbolt remains in the extended position. The interior thumb turn is configured to follow movement of the exterior swing thumb turn in the first direction and configured to remain in a first position in the first direction while the exterior swing thumb turn automatically swings back to the neutral position. The interior thumb turn thereby provides an indication that the deadbolt is in the extended position.

In some aspects, a deadbolt lock includes an escutcheon, a deadbolt configured to extend into an extended position and configured to retract into a retracted position, and a key cylinder disposed through the escutcheon. The deadbolt defining a deadbolt axis of movement along which the deadbolt moves between the extended and retracted positions. The key cylinder having an axis of rotation, with the axis of rotation of the key cylinder being nonintersecting with the deadbolt axis of movement.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a side view of a deadbolt lock according to an embodiment.

FIG. 2 is a front view of an exterior trim of a deadbolt lock according to an embodiment.

FIGS. 3A-D are front views of the actuation of an exterior thumb turn of a deadbolt lock according to an embodiment.

FIG. 4 is a diagram of the operation of the actuation of an exterior thumb turn of a deadbolt lock according to an embodiment.

FIG. 5 is a perspective view of a portion of an exterior trim of a deadbolt lock according to an embodiment.

FIG. 6 is a front view of an interior trim piece of a deadbolt lock according to an embodiment.

FIGS. 7A & 7B are front views of the actuation of an interior thumb turn of a deadbolt lock according to an embodiment.

FIG. 8 is a front perspective view of a portion of an exterior trim of a deadbolt lock with the exterior escutcheon removed according to an embodiment.

FIG. 9 is a rear perspective view of a portion of an exterior trim of a deadbolt lock with the exterior escutcheon removed according to an embodiment.

FIG. 10 is a front perspective view of a portion of an interior trim of a deadbolt lock with the interior escutcheon removed according to an embodiment.

FIG. 11 is a rear perspective view of a portion of an interior trim of a deadbolt lock with the interior escutcheon removed according to an embodiment.

FIG. 12 is a side perspective view of a deadbolt lock according to an embodiment.

### DETAILED DESCRIPTION

Conventional motorized deadbolt locks often utilize a motor to automatically extend and retract a deadbolt. In these cases, the motor may be triggered upon user identification or verification, such as entering a code on a pin pad, presenting a key card or phone, or presenting a biometric verification. In these conventional motorized deadbolt lock systems, issues may arise with the automatic retraction and extraction. For example, when in use with doors that cant and/or pivot, the deadbolt of a motorized mortice deadbolt lock may jam or be driven into the strike of the door. This may cause a user to believe that the deadbolt is malfunctioning.

In view of the above, the inventors have recognized the benefits of a deadbolt lock that can be locked and unlocked via a mechanical thumb turn. A deadbolt lock having a mechanical thumb turn may have an interior trim and an exterior trim, both with corresponding thumb turns such that from the inside, the thumb turn may always be free to operate, and from the outside, the thumb turn may require user identification or verification to be operated, as will be described further herein. With this device, the user can manually retract and extend the thumb turn. In addition, the user may be able to always determine the position of the deadbolt based on the position of the thumb turn(s).

Additionally, typical deadbolt door locks with a thumb turn have a thumb turn that protrudes directly outward from the lock body or escutcheon in a direction perpendicular to the face of the door. This type of thumb turn may require a significant force to be turned because there is a small or no lever arm between where a user applies a force and the thumb turn rotation axis. In addition, the thumb turn may be difficult to grasp when extending outward from the escutcheon. Further, such conventional thumb turns require rotation of the thumb turn, which may be difficult for some users.

In view of the above, the inventors have recognized the benefits of a door lock with a swing thumb turn that extends below an escutcheon of the door lock. In this way, more torque can be applied to the thumb turn than with traditional thumb turns resulting in greater mechanical advantage. Further, this may be beneficial to comply with ADA requirements, especially for individuals that may have difficulty rotating a conventional thumb turn, whether due to the input torque required or due to an inability to suitably grasp the thumb turn). A thumb turn extending below the escutcheon/trim may be easier to access such as by the user's knuckles or elbows. This may also be beneficial should the user not wish to touch the thumb turn with their fingers for cleanliness reasons or in situations where their hands are full, and the thumb turn is only accessible with other parts of their body.

In some embodiments, a deadbolt lock may include an exterior trim and an interior trim. The exterior trim may be configured to be mounted to an exterior surface of a door and the interior trim may be configured to be mounted to an interior surface of a door. It should be appreciated that the “exterior” of the door is on the unsecured side of space whereas the interior of the door is on the secured side of the space. In this respect, the door may be considered an entrance door to a home or office or other room desired to be secured. The deadbolt lock may include a thumb turn operatively coupled to the exterior trim and a thumb turn operatively coupled to the interior trim.

The deadbolt lock includes a deadbolt that can extend and retract to engage and disengage a door jamb, respectively. The deadbolt is fitted within an edge of the door in a conventional manner. The deadbolt is operatively coupled to the interior trim and to the exterior trim.

The deadbolt lock may be configured as an electronic lock such that the deadbolt lock is only able to be actuated from the exterior when presented with authenticated credentials. As such, the exterior trim may include an exterior thumb turn that is only able to extend and retract the deadbolt when the exterior trim is presented with authenticated credentials. In this respect, a controller in the deadbolt lock may receive the authenticated credentials and then actuate a motor to cause an engagement of a clutch so that the deadbolt may be actuated by the user from the exterior side via the exterior thumb turn. The motor itself does not move the deadbolt; instead, manual input to a thumb turn (and/or a physical key as will be described below) is required to move the deadbolt. In some embodiments, the thumb turn may be a swing thumb turn, such that a user input may move the thumb turn in a curved path around the corresponding trim. The motor simply is used to actuate a clutch which then engages with the exterior thumb turn allowing the exterior thumb turn to then move the deadbolt. As a result, the motor draws low power from the associated batteries which may be four alkaline batteries (such as AA batteries), a 9V battery or other portable power sources as the disclosure is not so limited. Further, any mismatch between the deadbolt and the door jamb can be overcome by a user manually actuating the thumb turn (or key); whereas a direct motor actuation of the deadbolt may either draw too much power from the batteries or may simply provide an insufficient force to overcome any such binding between the deadbolt and door jamb. It should be understood that any type of suitable motor or actuator may be used to engage the clutching mechanism.

The user interface to present the credentials may be a physical keypad, or touch screen keypad, an RFID reader, a phone, or a biometric (fingerprint, handprint, eye scan, etc.) reader. Combinations of the above are also contemplated. The user interface may be integrated into the exterior trim as shown or may be a separate component located adjacent to the deadbolt lock or nearby and may communicate therewith either by Bluetooth, Wi-Fi, other low power wireless protocols, or hard wired. Other user interfaces are also contemplated as the present disclosure is not limited in this respect.

In some embodiments the interior thumb turn may be permanently operable to retract and extend the deadbolt and does not require user authentication. Thus, the interior thumb turn may not require a clutching mechanism to operatively couple the interior thumb turn with the deadbolt. In some embodiments, the interior thumb turn may always move with the deadbolt, such that even if the deadbolt is retracted via the exterior trim, the interior thumb turn will also be moved. The movement of the thumb turn will be described further herein.

In some embodiments, the exterior thumb turn is biased into a neutral position, with the exterior thumb turn actuatable to move from the neutral vertical position in a first direction toward the frame of the door (also referred to as the door jamb) to extend the deadbolt. Once deployed, that is, once the deadbolt is in the extended position, the exterior thumb turn is released by the user and the exterior thumb turn can then automatically move back to the neutral position while the deadbolt remains in the extended position. In some embodiments, only the exterior thumb turn is biased to the neutral position. The interior thumb turn may be configured to remain in a position towards the first direction while the deadbolt is extended, as will be discussed further herein. This may allow a user on the interior to determine the state of the deadbolt based on the position of the interior thumb turn.

Once the exterior thumb turn returns to the neutral position, the exterior thumb turn is actuatable to move from the neutral vertical position in a second direction toward the hinge side of the door and opposite the first direction to retract the deadbolt. Here again, the exterior thumb turn is released by the user and the exterior thumb turn can then automatically move back to the neutral position while the deadbolt remains in the retracted position.

Since the interior thumb turn may not return to the neutral vertical position when the deadbolt is extended, a user can retract the deadbolt by manually moving the interior thumb turn back to the neutral position.

In one embodiment, the exterior thumb turn is biased toward the neutral vertical position by one or more springs (not shown). When the exterior thumb turn is in the vertical neutral position, the exterior thumb turn is held in that position with a detent. The holding force associated with this detent may be overcome by a user but may be sufficient to prevent the one or more springs from dislodging the exterior thumb turn when not in use. Of course, a detent is not required. In one embodiment, two springs may be employed such that the balancing of the springs causes the exterior thumb turn to rest in the neutral vertical position. The use of such two springs may be instead of or in addition to the detent.

In some embodiments, the deadbolt lock may include a motor coupled to a clutch. The clutch may be configured to move to a disengaged position upon expiration of a time period after the authenticated credential is received by the user interface, thereby rendering the exterior swing thumb turn inoperable to move the deadbolt. In this regard, the motor is energized for the time period, allowing the clutch to become engaged. Operation of the exterior thumb turn to cause movement of the deadbolt is only possible during this time period. Once this time period expires (i.e., times out), the motor is de-energized so that the clutch can move to its home position where it is disengaged, and therefore prevent the exterior thumb turn from actuating the deadbolt. The clutch may be biased towards a disengaged position via a spring, such that when the motor is de-energized, the clutch may be moved to the disengaged position. It should be appreciated that the controller could energize the motor to cause the clutch to engage and then the motor would be de-energized while the clutch remains engaged. After a time period, the motor can be re-energized causing the clutch to disengage and then the motor would be deenergized causing the clutch to disengage. The time period may be short, for example less than 5 seconds or less than 3 seconds. It should be appreciated that the motor may be a rotary motor (with a corresponding gearbox) or a linear motor or a solenoid or an electromagnetic latch, as the present disclosure is not limited in this regard.

In some embodiments, the interior thumb turn and/or exterior thumb turn is configured to swing along an arc, as will be apparent below. Alternatively, the interior thumb turn and/or exterior thumb turn may be configured as a slide so as to move linearly or near linearly.

In one embodiment, an interior and/or exterior thumb turn moves in an arc that is centered along an axis of movement of the deadbolt. In one embodiment, the thumb turn is configured to swing no more than 90 degrees in the first direction. In one embodiment, the thumb turn is configured to swing no more than 90 degrees in the second direction. In one embodiment, the thumb turn is configured to swing 45 degrees in the first direction. In one embodiment, the thumb turn is configured to swing 45 degrees in the second direction.

As previously mentioned, the deadbolt lock includes an interior trim that is configured to mount to the interior side of the door. The interior trim includes an interior thumb turn. As previously noted, the interior thumb turn is linked in its motion to the deadbolt, and motion is not through a motor and/or clutch where motion of the interior thumb turn is independent of movement of the deadbolt. Thus, movement of the interior thumb turn to a first position (toward the door edge) from the neutral position moves the deadbolt from the retracted position to the extended position. Similarly, movement of the interior thumb turn to the neutral position from the first position (away from the door edge) moves the deadbolt from the extended position to the retracted position. The position of the interior thumb turn can provide an indication that the deadbolt is in the extended position, indicating the deadbolt lock is locked, or that the deadbolt is in the retracted position, indicating the deadbolt lock is unlocked. Thus, the interior thumb turn may be used to lock and unlock the deadbolt lock from the inside, with the position of the interior thumb turn indicating the lock state of the deadbolt lock. That is, the interior thumb turn when resting in the neutral position can provide an indication that the deadbolt is in the retracted position, indicating the deadbolt lock is unlocked. When the interior thumb turn is in the first position toward the door edge, the first position of the interior thumb turn can provide an indication that the deadbolt is in the extended position, indicating the deadbolt lock is locked.

In one embodiment, with the exterior thumb turn moving in a first direction from the neutral position to extend the deadbolt and configured to automatically swing back to the neutral position while the deadbolt remains in the extended position, the interior thumb turn is configured to follow movement of the exterior thumb turn in the first direction but remains in a first position in the first direction, even while the exterior thumb turn automatically moves back to the neutral position.

This is similar in the opposite direction. With the exterior thumb turn moving in a second direction to a second position from the neutral position to retract the deadbolt (and configured to automatically swing back to the neutral position while the deadbolt remains in the retracted position), the interior thumb turn is configured to follow movement of the exterior thumb turn in the second direction but stops and remains in the neutral position while the exterior thumb turn continues to the second position. A detent may be arranged at the neutral position to loosely hold the interior thumb turn in the neutral position. In some embodiments a detent may not be present, and the interior thumb turn may be prevented from moving in the second direction past the neutral position due to its direct engagement with the deadbolt.

In some embodiments, the deadbolt lock includes a passage mode switch. In one embodiment, the passage mode switch is disposed on the interior trim. The passage mode switch, when activated, prevents the exterior thumb turn from moving the deadbolt to the extended position.

In some embodiments, the deadbolt lock includes a privacy mode switch. In one embodiment, the privacy mode switch is disposed on the interior trim. The privacy mode switch, when activated, prevents the exterior thumb turn from moving the deadbolt to the retracted position.

The privacy mode switch may be adjacent to the passage mode switch, or the passage mode switch and the privacy mode switch may be the same switch but activated differently. For example, a single switch may be actuated once for one mode and twice for the other mode.

In some embodiments, the deadbolt lock may include a key cylinder to override the user interface used primarily in the case of a battery power loss, though it could be used as a way to allow access when the user does not have the proper credentials but has the physical key. The key cylinder is disposed in a manner so as to be low profile. That is, the key cylinder does not extend much if at all beyond the surface of the exterior escutcheon.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

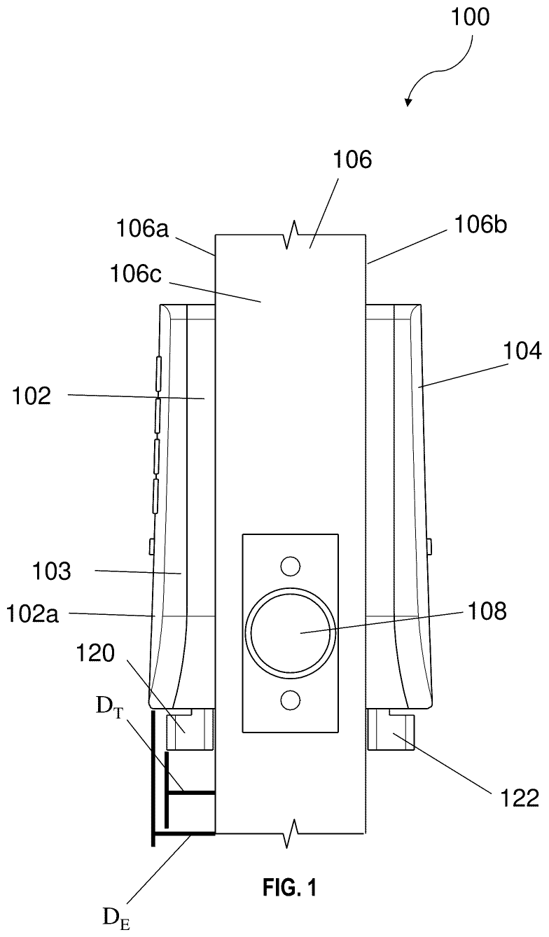

FIGS. 1-8 illustrate views of a deadbolt lock 100 according to various embodiments.

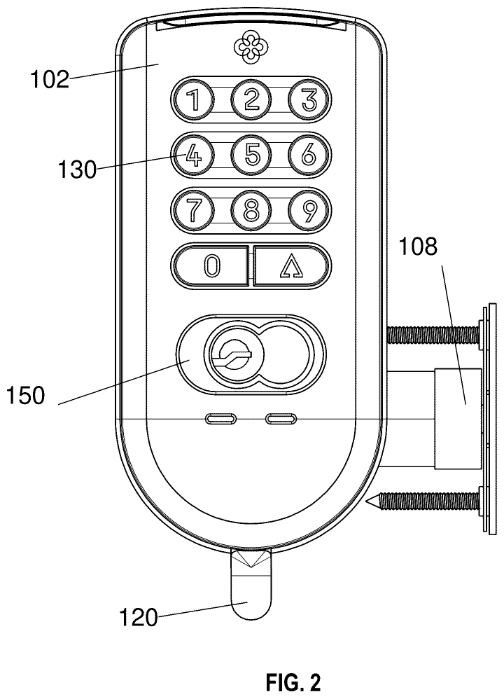

In some embodiments, as shown in FIGS. 1 and 2, the deadbolt lock 100 includes an exterior trim 102 and an interior trim 104. The exterior trim 102 is configured to be mounted to an exterior surface 106a of a door 106 and the interior trim 104 is configured to be mounted to an interior surface 106b of a door 106.

The deadbolt lock 100 includes a deadbolt 108 that can extend and retract to engage and disengage a door jamb, respectively. The deadbolt 108 is fitted within an edge 106c of the door 106 in a conventional manner. The deadbolt 108 is operatively coupled to the interior trim 104 and to the exterior trim 102.

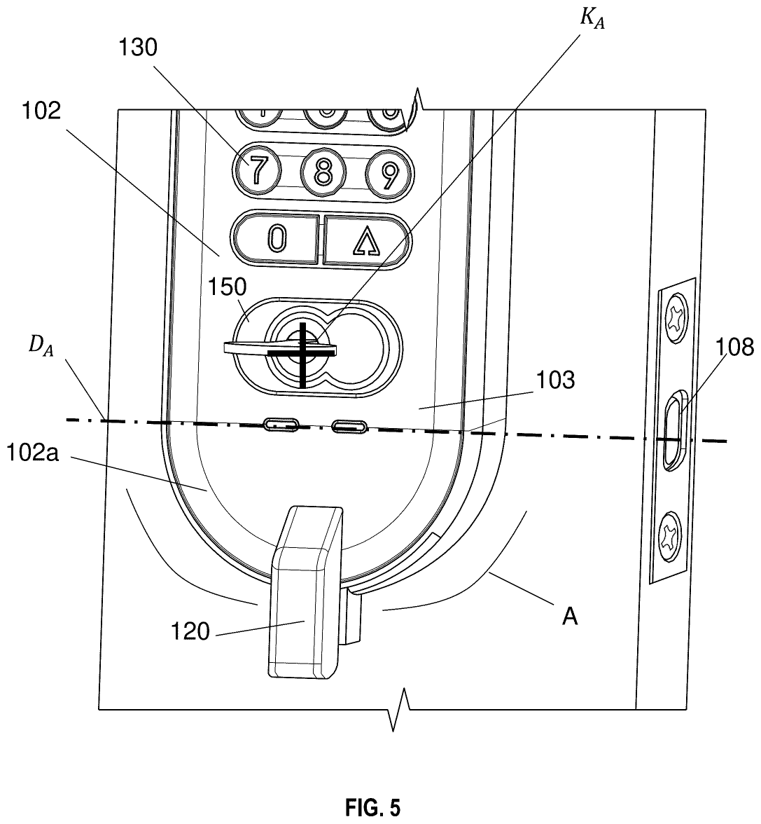

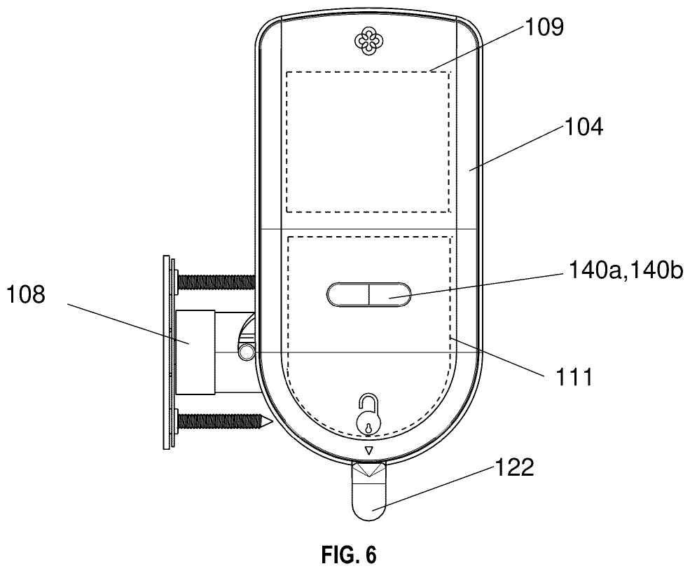

The deadbolt lock 100 is configured as an electronic lock such that when presented with authenticated credentials, the deadbolt lock 100 is able to be actuated from the exterior by a user. In this respect, a controller 107 (see FIG. 6) in the deadbolt lock 100 receives the authenticated credentials and then actuates a motor 105 that causes an engagement of a clutch 111 so that the deadbolt may be actuated by the user from the exterior trim 102 (see FIG. 9), as will be discussed further herein. The motor 105 itself does not move the deadbolt 108; instead, manual input to a thumb turn 120 (and/or key as will be described below) is required to move the deadbolt 108. In some embodiments, the motor may be powered via a battery 109 (see FIG. 6) or via a cable connection.

The user interface to present the credentials may be a physical keypad 130, as shown, or touch screen keypad, an RFID reader, a phone, or a biometric (fingerprint, handprint, eye scan, etc.) reader. Combinations of the above are also contemplated. The user interface may be integrated into the exterior trim 102 as shown or may be a separate component located adjacent to the deadbolt lock 100 or nearby and may communicate therewith either by Bluetooth, Wi-Fi, other low power wireless protocols, or hard wired. Other user interfaces are also contemplated as the present disclosure is not limited in this respect.

As shown in FIG. 2, the exterior trim of the deadbolt lock includes an exterior thumb turn 120 configured as a swing thumb turn 120 in that the thumb turn moves along an arc. The swing thumb turn 120 is operatively coupled to the deadbolt 108 such that movement of the swing thumb turn 120 causes the deadbolt 108 to extend or retract upon acceptance of the authenticated credentials.

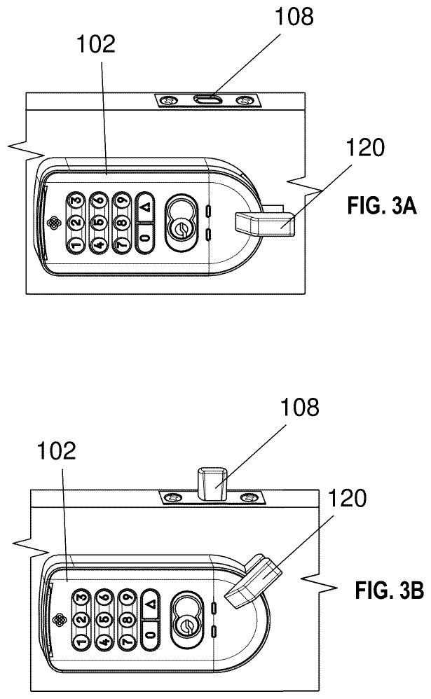

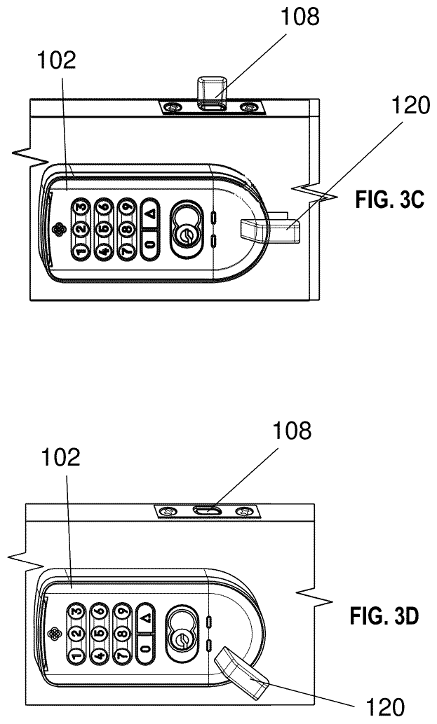

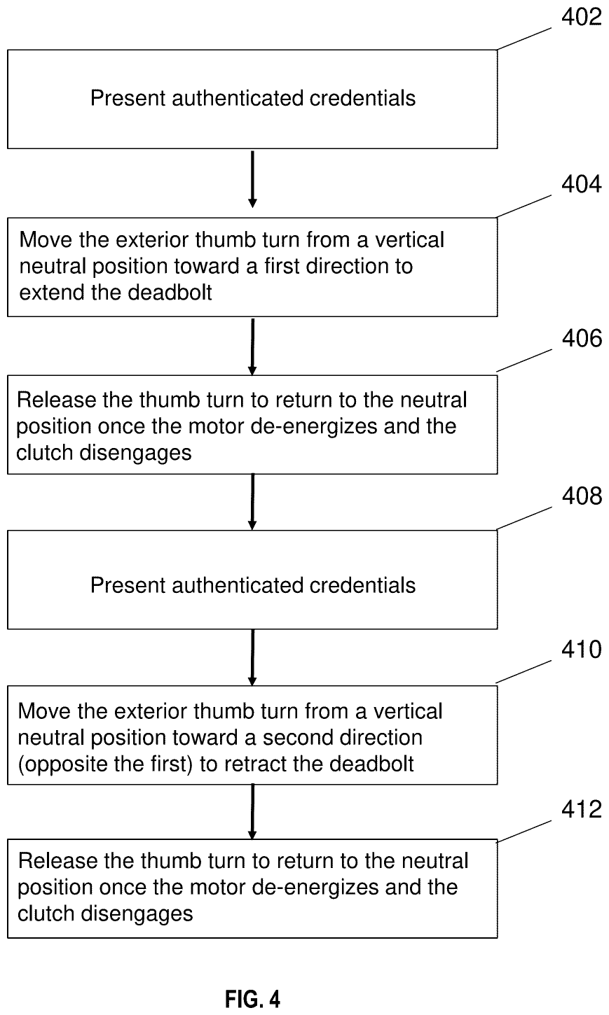

FIGS. 3A-D and FIG. 4 outline the operation of the exterior swing thumb turn 120. The swing thumb turn 120 is biased into a neutral starting position, as seen in FIG. 3A. When a user presents authenticated credentials to the door lock or via an exterior interface, as seen in box 402, the exterior thumb turn may then be operable to move the deadbolt. Then, as seen in box 404, a user may move the exterior thumb turn 120 from the neutral vertical position in a first direction toward the frame of the door 106 (also referred to as the door jamb, not shown in the figure) to extend the deadbolt 108. FIG. 3B shows the deadbolt 108 and the thumb turn 120 in the extended position. Once deployed, that is, once the deadbolt 108 is in the extended position, the swing thumb turn 120 is released by the user and the swing thumb turn 120 can then automatically swing back to the neutral position while the deadbolt 108 remains in the extended position, as shown in box 406 and FIG. 3C. The user may again present authenticated credentials as shown in box 410 to render the exterior thumb turn 120 operable to move the deadbolt 108. To retract the deadbolt, the user may now move the exterior thumb turn 120 from the neutral vertical position in a second direction toward the hinge side (not shown) of the door 106 and opposite the first direction to retract the deadbolt 108, as shown in box 410 and FIG. 3D. Here again, the swing thumb turn 120 is released by the user and the swing thumb turn 120 can then automatically swing back to the neutral position while the deadbolt 108 remains in the retracted position, as shown in box 412 and FIG. 3A.

In one embodiment, the swing thumb turn 120 is biased toward the neutral vertical position (as seen in FIG. 3A) by one or more springs 121 (See FIG. 9). When the swing thumb turn 120 is in the vertical neutral position, the swing thumb turn 120 is held in that position with a detent (not shown). The holding force associated with this detent may be overcome by a user but may be sufficient to prevent the one or more springs 121 from dislodging the swing thumb turn 120 when not in use. Of course, a detent is not required. In one embodiment, two springs 121 may be employed such that the balancing of the springs 121 causes the swing thumb turn to rest in the neutral vertical position. The use of such two springs 121 may be instead of or in addition to the detent.

In one embodiment, as shown in FIG. 5, the deadbolt lock 100 includes a key cylinder 150 to override the user interface 130 used primarily in the case of a battery power loss, though it could be used as a way to allow access when the user does not have the proper credentials but has the physical key. The key cylinder 150 is disposed in a manner so as to be low profile. That is, the key cylinder does not extend much beyond the surface of an exterior escutcheon 102a if at all.

In one embodiment, the deadbolt 108 defines a deadbolt axis of movement D_{A} along which the deadbolt 108 moves between the extended and retracted positions. The key cylinder 150, which is disposed through the escutcheon 102a, has an axis of rotation K_{A}. That axis of rotation K_{A} of the key cylinder 150 does not intersect the deadbolt axis of movement D_{A}. In the embodiment shown, the axis of rotation K_{A} is above the axis of movement D_{A}. In this way, the key cylinder 150, being offset in this manner, can be disposed within the profile of the escutcheon 102a and not protrude out beyond a major face 103 of the escutcheon by any significant amount if at all. Without wishing to be bound by theory, if the axis of rotation K_{A} had intersected with the axis of movement D_{A}, then the key cylinder 150 would need to extend beyond the escutcheon 102a because there would simply be insufficient space in the exterior trim 102 to accommodate the key cylinder 150 and the components of the deadbolt 108 needed to move the deadbolt 108.

It should be appreciated that the use of the key cylinder may be omitted, defining a “key free” experience where only electronic credential (BLE, RFID, Keypad, low power radio protocols) will be used to engage the clutching action described herein.

As shown in FIG. 5, in one embodiment, the deadbolt lock includes an exterior escutcheon 102a covering or otherwise part of the exterior trim piece. In one embodiment, as shown in FIG. 5, the swing thumb turn 120 moves in an arc A that is centered along the axis of movement D_{A} of the deadbolt. In one embodiment, the swing thumb turn 120 is configured to swing no more than 90 degrees in the first direction. In one embodiment, the swing thumb turn 120 is configured to swing no more than 90 degrees in the second direction. In one embodiment, the swing thumb turn 120 is configured to swing 45 degrees in the first direction. In one embodiment, the swing thumb turn 120 is configured to swing 45 degrees in the second direction.

In one embodiment, as shown in FIG. 1, a depth D_{E} of the escutcheon is less than 1 inch. In one embodiment, the depth of the escutcheon is less than 0.85 inches. In one embodiment, a depth D_{T} of the thumb turn 120 is less than 0.5 inches, as measured from the surface of the door 106.

It should be understood that the interior thumb turn 122 may be configured in the same manner and with the same type of swing movement as the exterior thumb turn 120 or the interior thumb turn 122 may have a different configuration, as the disclosure is not so limited.

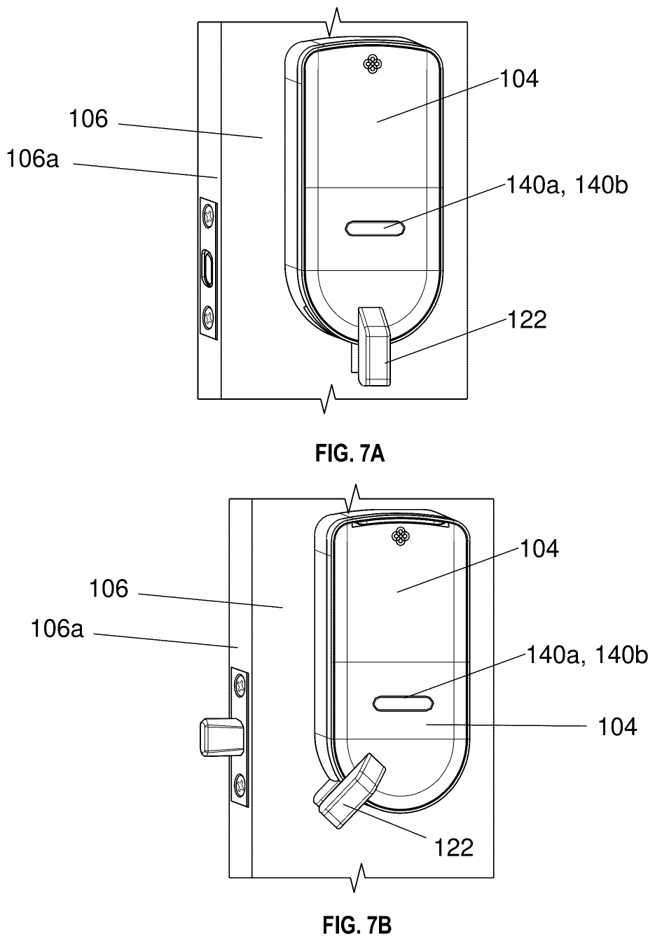

As shown in FIGS. 6 and 7A-B, in one embodiment, the deadbolt lock includes an interior trim 104 that is configured to mount to the interior side 106b of the door 106. The interior trim 104 includes an interior thumb turn 122. The interior thumb turn 122 is linked in its motion to the deadbolt 108, and motion is not through a motor and/or clutch where motion of the interior thumb turn 122 is independent of movement of the deadbolt. Thus, movement of the interior thumb turn 122 to a first position (toward the door edge 106c) from the neutral position (see FIG. 7A) moves the deadbolt 108 from the retracted position to the extended position (see FIG. 7B). Similarly, movement of the interior thumb turn 122 to the neutral position from the first position (away from the door edge 106c) moves the deadbolt 108 from the extended position to the retracted position. The position of the interior thumb turn 122 can provide an indication that the deadbolt 108 is in the extended position, indicating the deadbolt lock 100 is locked, or that the deadbolt 108 is in the retracted position, indicating the deadbolt lock 100 is unlocked Thus, the interior thumb turn 122 may be used to lock and unlock the deadbolt lock 100 from the inside, with the position of the interior thumb turn 122 indicating the lock state of the deadbolt lock. That is, the interior thumb turn 122 when resting in the neutral position can provide an indication that the deadbolt 108 is in the retracted position, indicating the deadbolt lock 100 is unlocked. When the interior thumb turn 122 is in the first position toward the door edge 106c, the first position of the interior thumb turn 122 can provide an indication that the deadbolt 108 is in the extended position, indicating the deadbolt lock 100 is locked.

In one embodiment, with the exterior thumb turn 120 moving in a first direction from the neutral position to extend the deadbolt 108 and configured to automatically swing back to the neutral position while the deadbolt 108 remains in the extended position, the interior thumb turn 122 is configured to follow movement of the exterior thumb turn 120 in the first direction but remains in a first position in the first direction, even while the exterior thumb turn 120 automatically moves back to the neutral position.

This is similar in the opposite direction. With the exterior thumb turn 120 moving in a second direction to a second position from the neutral position to retract the deadbolt 108 (and configured to automatically swing back to the neutral position while the deadbolt 108 remains in the retracted position), the interior thumb turn 122 is configured to follow movement of the exterior thumb turn 120 in the second direction but stops and remains in the neutral position while the exterior thumb turn 120 continues to the second position. A detent (not shown) may be arranged at the neutral position to loosely hold the interior thumb turn 122 in the neutral position.

In some embodiments, the deadbolt lock 100 includes a passage mode switch 140a. In one embodiment, the passage mode switch 140a is disposed on the interior trim 104, as shown in FIG. 6. The passage mode switch 140a, when activated, prevents the exterior thumb turn 120 from moving the deadbolt 108 to the extended position.

In some embodiments, the deadbolt lock 100 includes a privacy mode switch 140b. In one embodiment, the privacy mode switch 140b is disposed on the interior trim 104, as shown in FIG. 6. The privacy mode switch 140b, when activated, prevents the exterior thumb turn 120 from moving the deadbolt 108 to the retracted position.

The privacy mode switch 140b may be adjacent to the passage mode switch 140a or the passage mode switch 140a and the privacy mode switch 140b may be the same switch but activated differently. For example, a single switch may be actuated once for one mode and twice for the other mode.

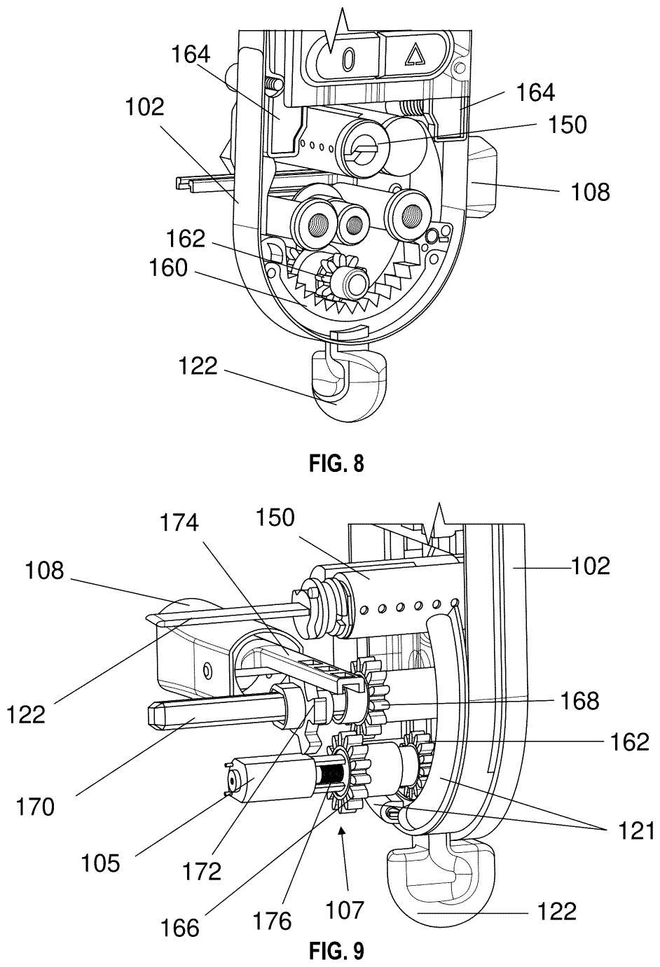

FIG. 8 shows the exterior trim 102 with the major face 103 removed to reveal the internal workings. The exterior trim 102 includes a curved gear rack 160 coupled to the exterior thumb turn 122 and configured to slide within the exterior trim 102 as the exterior thumb turn 120 is swung around the escutcheon 102a, as previously described. The curved gear rack 160 is engaged with first gear 162, such that movement of the curved gear rack 160 will rotate first gear 162. The exterior trim 102 may include blocks 164 to prevent the curved gear rack 160 and the exterior thumb turn 120 from being rotated past a certain point.

FIG. 9 shows the rear perspective of the inner workings of the exterior trim 102. As briefly mentioned, the deadbolt lock 100 includes a motor 105 coupled to a clutch 111. Clutch 107 includes clutch gear 166 configured to rotate in conjunction with first gear 162. When a user presents authenticated credentials, as previously discussed, the motor 105 may be activated to move the clutch gear 166 forward to engage with second gear 168 such that, as clutch gear 166 rotates (due to rotation from first gear 162 caused by movement of exterior thumb turn 120), second gear 168 will also rotate. It should be appreciated that motor 105 includes a screw or may be considered a screw motor, such that as the motor rotates, the gears 162 and 166 move forward and backward to engage with the gear rack 160 and second gear 168, respectively. Further, a shaft 170 rotationally couples second gear 168 to a pinion gear 172. Finally, pinion gear 172 is operatively coupled to rack 174, which is attached to the deadbolt 108. Hence, as the pinion gear 172 rotates, the rack 174 and deadbolt 108 are driven outward and/or inward to respectively extend and retract the deadbolt 108. Therefore, as the exterior thumb turn 120 is moved around the escutcheon 102a, the curved gear rack 160 rotates first gear 162, which transmits rotation to clutch gear 166. If the motor 105 has not actuated the clutch 107, then the clutch gear 166 will rotate freely. If the motor 105 has actuated the clutch gear 166 forward (due to authentication being provided), then the clutch gear 166 will engage with and rotate second gear 168. This rotation will transmit through shaft 170 to pinion gear 172 which will actuate the rack 174 and deadbolt 108. In some embodiments, the deadbolt lock may not include second gear 168. Rather, the clutch gear 166 may be actuated to directly couple with pinion gear 172 to drive the rack 174. In some embodiments, the rack 174 may be formed integrally with the deadbolt 108 or may be attached separately. It should be understood that a different configuration of gears may be utilized to transmit the movement of the exterior thumb turn 120 to the deadbolt 108.

As previously mentioned, the clutch 107 is configured to move to a disengaged position upon expiration of a time period after the authenticated credential is received by the user interface, thereby causing the exterior thumb turn 120 to become inoperable to move the deadbolt 108. In this regard, the motor 105 is energized for the time period, allowing the clutch 107 to become engaged (via the clutch gear 166 engaging the second gear 168). Operation of the exterior thumb turn 120 to cause movement of the deadbolt 108 is only possible during this time period. Once this time period expires (i.e., times out), the motor 105 is de-energized so that the clutch 107 can move to its home position where it is disengaged, and therefore preventing the thumb turn 120 from actuating the deadbolt 108. In some embodiments, the clutch gear may be biased towards the disengaged position via clutch spring 176. It should be appreciated that the controller 107 (see FIG. 6) could energize the motor 105 to cause the clutch 107 to engage and then the motor 105 would be de-energized while the clutch 107 remains engaged. After a time period, the motor 105 can be re-energized causing the clutch 107 to disengage and then the motor 105 would be deenergized causing the clutch 107 to disengage. The time period may be short, for example less than 5 seconds or less than 3 seconds. It should be appreciated that the motor 105 may be a rotary motor (with a corresponding gearbox) or a linear motor or a solenoid, as the present disclosure is not limited in this regard.

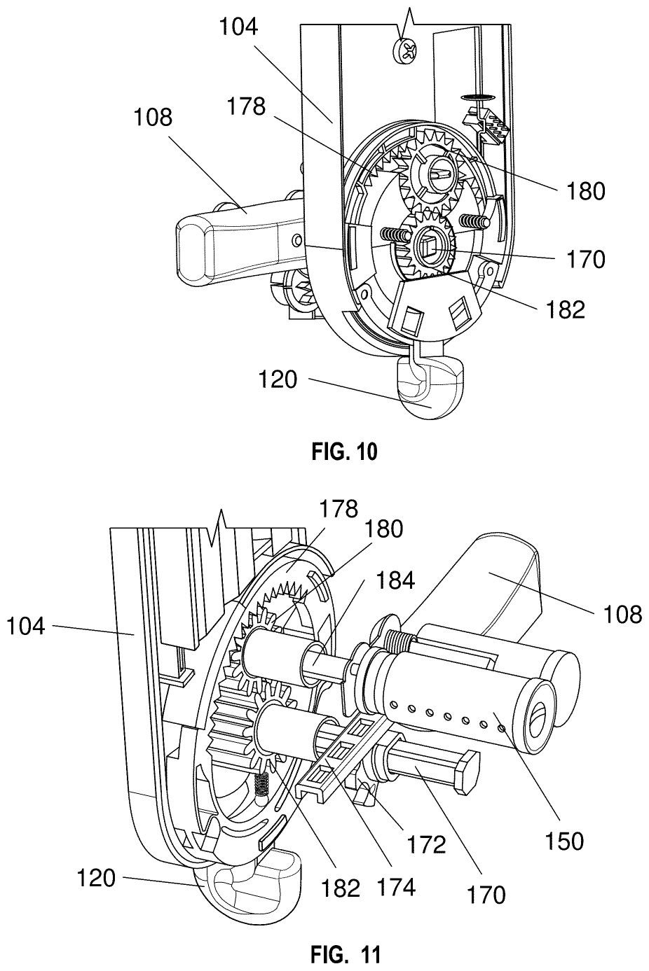

FIG. 10 shows a front perspective view of the interior trim 104 with the front face plate removed to show the inner workings. The interior trim 104 includes a second curved gear rack 178 coupled to the interior thumb turn 122 and configured to slide within the interior trim 104 as the interior thumb turn 122 is swung around the interior trim 104, as previously described. Second curved gear rack 178 is engaged with a third gear 180, which is engaged with fourth gear 182. Thus. As the interior thumb turn 122 is moved by a user, the second curved gear rack 178 rotates the third gear 180, which rotates the fourth gear 182.

FIG. 11 shows a rear perspective view of the inner workings of the interior trim 104. As seen in FIGS. 10 and 11, shaft 170 is rotationally coupled to fourth gear 182. Thus, shaft 170 fits through and is rotationally coupled to fourth gear 182, pinion gear 172 and second gear 168. Shaft 170 may have a square, rectangular, or triangular face to fit within corresponding pockets in the fourth gear 182, pinion gear 172 and second gear 168 to transfer torque (rotation) through these gears.

As fourth gear 182 is rotated, shaft 170 transmits this rotation to the pinion gear 172 to drive the deadbolt 108 via rack 174. Hence, since there is no clutch mechanism to couple the movement of the interior thumb turn 122 to movement of the deadbolt 108, a user does not need to present authentication to extend and retract the deadbolt 108 via the interior thumb turn 122, as previously discussed. As the interior thumb turn 122 is moved, rotation of the second curved gear rack 178 is transmitted through third gear 180, fourth gear 182, and pinion gear 172 to drive rack 174 and deadbolt 108.

As previously mentioned, the interior thumb turn 120 may be configured to move with the deadbolt 108 when the deadbolt 108 is moved by the external thumb turn 122. More specifically, when the clutch is engaged and the movement of the external thumb turn 122 transmits rotation to the shaft 170, as previously described, the shaft 170 will transmit the rotation to the fourth gear 182. The fourth gear 182 will then rotate third gear 180 which will move the second curved gear rack 178 and the interior thumb turn 120. This is effectively the reverse of the operation of when the interior thumb turn 120 is manually moved.

As previously discussed, if the exterior thumb turn 122 is moved to extend the deadbolt 108, the exterior thumb turn 122 may return to the neutral starting position when the clutch 107 disengages. The clutch 107 may disengage after the lapse of a period of time after user credentials are presented. One or more springs 121 may bias the exterior thumb turn 122 to the neutral starting position. However, since the interior thumb turn 120 moves independently of the operation of the clutch 107, the interior thumb turn 120 may be configured to remain in the position that the interior thumb turn is brought to when extending the deadbolt 108 until the deadbolt 108 is retracted (via the interior thumb turn 120 or the exterior thumb turn 122).

Additionally, as seen in FIG. 11, a key shaft 184 rotationally couples the key cylinder 150 to third gear 180, such that when a key in inserted into and rotated in the key cylinder 150, the key shaft 184 transmits this rotation to third gear 180. As discussed, the rotation of third gear 180 is transmitted through fourth gear 182 and pinion gear 172 to drive the rack 174 and deadbolt 108. In this way, the operation of the key cylinder 150 to extend and retract the deadbolt 108 is independent of the operation of the clutch 107.

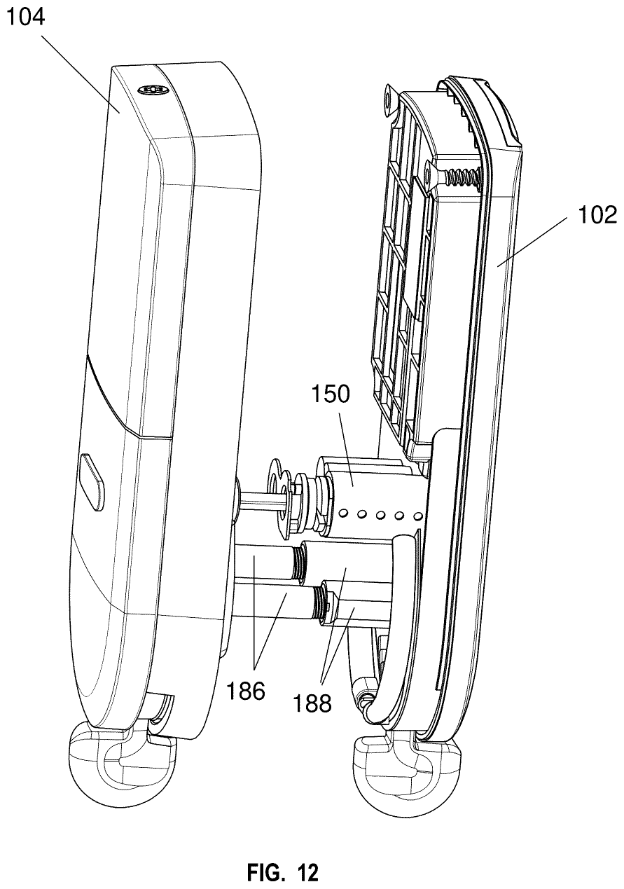

As seen in FIG. 12, the interior trim 104 includes one or more threaded pins 186 to fit into corresponding threaded receptacles 188 of the exterior trim to removably engage the interior trim 104 and exterior trim 102. In some embodiments, the exterior trim 102 and the interior trim 104 may not be directly coupled via threaded fasteners. Rather, the exterior trim 102 and interior trim 104 may be held in place solely via corresponding attachment to the door 106.

The present disclosure is inclusive of the following concepts:

### Biased Toward Neutral Position

A1. A deadbolt lock, comprising:
a deadbolt configured to extend into an extended position and configured to retract into a retracted position; and
a thumb turn operatively coupled to the deadbolt and biased into a neutral position, with the thumb turn actuatable to move from the neutral position in a first direction to extend the deadbolt and configured to automatically move back to the neutral position while the deadbolt remains in the extended position;
wherein the thumb turn is actuatable to move from the neutral position in a second direction opposite the first direction to retract the deadbolt and configured to automatically move back to the neutral position while the deadbolt remains in the retracted position.
   A2. The deadbolt lock of claim A1, wherein the thumb turn is configured to be held in the neutral position with a detent.
   A3. The deadbolt lock of claim A1, further comprising a user interface configured to receive a credential, with the thumb turn being operable only when an authenticated credential is received by the user interface.
   A4. The deadbolt lock of claim A3, wherein the deadbolt lock is an electronic lock having a clutch mechanism, wherein the clutch mechanism is configured to move to an engaged position when an authenticated credential is received by the user interface, thereby causing the thumb turn to automatically return to the neutral position and become operable to move the deadbolt.
   A5. The deadbolt lock of claim A4, wherein the clutch mechanism is configured to move to a disengaged position upon expiration of a time period after the authenticated credential is received by the user interface, thereby causing the thumb turn to automatically move back to the neutral position and become inoperable to move the deadbolt.
   A6. The deadbolt lock of claim A5, further comprising an interior thumb turn coupled to the deadbolt, wherein the interior thumb turn is configured to be operable to move the deadbolt regardless of the operability of the thumb turn.
   A7. The deadbolt lock of claims A3-A6, wherein the user interface is a keypad.
   A8. The deadbolt lock of claims A4-A7, further comprising a motor, wherein the clutch mechanism cooperates with a motor.
   A9. The deadbolt lock of claims A1-8, further comprising a passage mode switch, with the passage mode switch, when activated, configured to prevent the exterior thumb turn from moving the deadbolt to the extended position.
   A10. The deadbolt lock of claims A1-A-9, further comprising a privacy mode switch, with the privacy mode switch, when activated, configured to prevent the exterior thumb turn from moving the deadbolt to the retracted position.

### Extending Below Escutcheon

B1. A deadbolt lock, comprising:
an escutcheon;
a deadbolt configured to extend into an extended position and configured to retract into a retracted position; and
a thumb turn operatively coupled to the deadbolt and extending below the escutcheon, with the thumb turn actuatable to move in a first direction to extend the deadbolt and actuatable to move in a second direction opposite the first direction to retract the deadbolt.
   B2. The deadbolt lock of claim B1, wherein the thumb turn is configured move to no more than 90 degrees in the first direction.
   B3. The deadbolt lock of claims B1-B2, wherein the thumb turn is configured to move no more than 90 degrees in the second direction.
   B4. The deadbolt lock of claims B1-B3, further comprising a user interface configured to receive a credential, with the thumb turn being operable only when an authenticated credential is received by the user interface.
   B5. The deadbolt lock of claim B4, wherein the deadbolt lock is an electronic lock having a clutch mechanism, wherein the clutch mechanism is configured to move to an engaged position when an authenticated credential is received by the user interface, thereby causing the thumb turn to become operable to move the deadbolt.
   B6. The deadbolt lock of claim B5, wherein the clutch mechanism is configured to move to a disengaged position upon expiration of a time period after the authenticated credential is received by the user interface, thereby causing the thumb turn to become inoperable to move the deadbolt.
   B7. The deadbolt lock of claim B6, further comprising an interior thumb turn coupled to the deadbolt, wherein the interior thumb turn is configured to be operable to move the deadbolt regardless of the operability of the thumb turn.
   B8. The deadbolt lock of claims B4-B7, wherein the user interface is a keypad.
   B9. The deadbolt lock of claims B5-B8, further comprising a motor, wherein the clutch mechanism cooperates with a motor.
   B10. The deadbolt lock of claims B1-B9, further comprising a passage mode switch, with the passage mode switch, when activated, configured to prevent the exterior thumb turn from moving the deadbolt to the extended position.
   B11. The deadbolt lock of claims B1-B10, further comprising a privacy mode switch, with the privacy mode switch, when activated, configured to prevent the exterior thumb turn from moving the deadbolt to the retracted position.

### Interior Thumb Turn Remains in Position

C1. A deadbolt lock, comprising:
an interior trim including an interior thumb turn and configured to be mounted on in interior side of a door;
an exterior trim including an exterior thumb turn and configured to be mounted on an exterior side of a door;
a deadbolt operatively connected to the interior trim and the exterior trim, the deadbolt configured to extend into an extended position and configured to retract into a retracted position; and
the exterior thumb turn operatively coupled to the deadbolt and biased into a neutral position, with the exterior thumb turn being actuatable to move from the neutral position in a first direction to extend the deadbolt and configured to automatically move back to the neutral position while the deadbolt remains in the extended position, and with the interior thumb turn configured to follow movement of the exterior thumb turn in the first direction and configured to remain in a first position in the first direction while the exterior thumb turn automatically moves back to the neutral position, with the interior thumb turn thereby providing an indication that the deadbolt is in the extended position.
   C2. The deadbolt lock of claim C1, wherein the exterior thumb turn is actuatable to move from the neutral position in a second direction opposite the first direction to retract the deadbolt and configured to automatically move back to the neutral position while the deadbolt remains in the retracted position, with the interior thumb turn configured to follow the movement of the exterior thumb turn in the second direction and configured to remain in in the neutral position while the exterior thumb turn continues to the second position, with the interior thumb turn thereby providing an indication that the deadbolt is in the retracted position when the interior thumb turn ins in the neutral position.
   C3. The deadbolt lock of claims C1-C2, further comprising a passage mode switch, with the passage mode switch, when activated, configured to prevent the exterior thumb turn from moving the deadbolt to the extended position.
   C4. The deadbolt lock of claims C1-C3, further comprising a privacy mode switch, with the privacy mode switch, when activated, configured to prevent the exterior thumb turn from moving the deadbolt to the retracted position.
   C5. The deadbolt lock of claims C1-C4, further comprising a user interface configured to receive a credential, with the exterior thumb turn being operable only when an authenticated credential is received by the user interface.
   C6. The deadbolt lock of claim C5, wherein the deadbolt lock is an electronic lock having a clutch mechanism, wherein the clutch mechanism is configured to move to an engaged position when an authenticated credential is received by the user interface, thereby causing the exterior thumb turn to become operable to move the deadbolt.
   C7. The deadbolt lock of claim C6, wherein the clutch mechanism is configured to move to a disengaged position upon expiration of a time period after the authenticated credential is received by the user interface, thereby causing the exterior thumb turn to become inoperable to move the deadbolt.
   C8. The deadbolt lock of claim C7, wherein the interior thumb turn is configured to be operable to move the deadbolt regardless of the operability of the exterior thumb turn.
   C9. The deadbolt lock of claims C5-C8, wherein the user interface is a keypad.
   C10. The deadbolt lock of claims C5-C9, further comprising a motor, wherein the clutch mechanism cooperates with the motor.
   C11. The deadbolt lock of claims C1-C10, wherein the exterior thumb turn is configured to be held in the neutral position with a detent.

### Key Override

D1. A deadbolt lock, comprising:
an escutcheon;
a deadbolt configured to extend into an extended position and configured to retract into a retracted position, the deadbolt defining a deadbolt axis of movement along which the deadbolt moves between the extended and retracted positions; and
a key cylinder disposed through the escutcheon and having an axis of rotation, the axis of rotation of the key cylinder being nonintersecting with the deadbolt axis of movement.
   D2. The deadbolt lock of claim D1, wherein the axis of rotation is above the axis of movement.
   D3. The deadbolt lock of claims D1-D2, wherein the key cylinder does not extend beyond a major face of the escutcheon.
   D4. The deadbolt lock of claims D1-D3, wherein a depth of the escutcheon is less than 1 inch, or wherein the depth of the escutcheon is less than 0.85 inches.
   D5. The deadbolt lock of claims D1-D4, further comprising a thumb turn operatively coupled to the deadbolt.
   D6. The deadbolt lock of claim D5, wherein a depth of the thumb turn is less than 0.5 inches.
   D7. The deadbolt lock of claims D1-D6, further comprising a user interface configured to receive a credential, with the thumb turn being operable only when an authenticated credential is received by the user interface.
   D8. The deadbolt lock of claims D1-D7, wherein the deadbolt lock is an electronic lock having a clutch mechanism, wherein the clutch mechanism is configured to move to an engaged position when an authenticated credential is received by the user interface, thereby causing the thumb turn to become operable to move the deadbolt.
   D9. The deadbolt lock of claim D8, wherein the clutch mechanism is configured to move to a disengaged position upon expiration of a time period after the authenticated credential is received by the user interface, thereby causing the thumb turn to become inoperable to move the deadbolt.
   D10. The deadbolt lock of claims D8-D9, further comprising an interior thumb turn coupled to the deadbolt, wherein the interior thumb turn is configured to be operable to move the deadbolt regardless of the operability of the thumb turn.
   D11. The deadbolt lock of claims D8-D10, wherein the user interface is a keypad.
   D12. The deadbolt lock of claims D9-D11, further comprising a motor, wherein the clutch mechanism cooperates with the motor.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A deadbolt lock, comprising:
an escutcheon;
a deadbolt configured to extend into an extended position and configured to retract into a retracted position; and
a thumb turn operatively coupled to the deadbolt and extending below the escutcheon, with the thumb turn actuatable to move in a first direction to extend the deadbolt and actuatable to move in a second direction opposite the first direction to retract the deadbolt.

2. The deadbolt lock of claim 1, further comprising a user interface configured to receive a credential, with the thumb turn being operable only when an authenticated credential is received by the user interface.

3. The deadbolt lock of claim 2, wherein the deadbolt lock is an electronic lock having a clutch mechanism, wherein the clutch mechanism is configured to move to an engaged position when the authenticated credential is received by the user interface, thereby causing the thumb turn to become operable to move the deadbolt.

4. The deadbolt lock of claim 3, wherein the clutch mechanism is configured to move to a disengaged position upon expiration of a time period after the authenticated credential is received by the user interface, thereby causing the thumb turn to become inoperable to move the deadbolt.

5. The deadbolt lock of claim 4, further comprising an interior thumb turn coupled to the deadbolt, wherein the interior thumb turn is configured to be operable to move the deadbolt regardless of the operability of the thumb turn.

6. The deadbolt lock of claim 2, wherein the user interface is a keypad.

7. The deadbolt lock of claim 3, further comprising a motor, wherein the clutch mechanism cooperates with the motor.

8. The deadbolt lock of claim 1, further comprising a passage mode switch, with the passage mode switch, when activated, configured to prevent the thumb turn from moving the deadbolt to the extended position.

9. The deadbolt lock of claim 1, further comprising a privacy mode switch, with the privacy mode switch, when activated, configured to prevent the thumb turn from moving the deadbolt to the retracted position.

10. The deadbolt lock of claim 1, wherein the thumb turn is configured to swing through an arc.

11. The deadbolt lock of claim 10, wherein the thumb turn is configured to swing no more than 90 degrees in the first direction.

12. The deadbolt lock of claim 10, wherein the thumb turn is configured to swing no more than 90 degrees in the second direction.

13. A method of operation of a deadbolt lock having an escutcheon and a swing thumb turn extending below the escutcheon, the method comprising:
upon authentication of credentials presented by a user, engaging a clutch mechanism to operatively couple the swing thumb turn to a deadbolt; and
upon swinging of the swing thumb turn along an arc in a first direction to extend the deadbolt, disengaging the clutch mechanism after a lapse of a period of time to render the swing thumb turn inoperable to move the deadbolt.

14. The method of claim 13, wherein the credentials are presented by the user to a user interface.

15. The method of claim 14, wherein the user interface is a keypad.

16. The method of claim 13, wherein the deadbolt lock further comprises an interior thumb turn coupled to the deadbolt, wherein the interior thumb turn is configured to be operable to move the deadbolt regardless of the operability of the swing thumb turn.

17. The method of claim 13, wherein a motor cooperates with the clutch mechanism to engage and disengage the clutch mechanism.

18. The method of claim 13, further comprising:
upon further authentication of credentials presented by the user, engaging the clutch mechanism again to operatively couple the swing thumb turn to the deadbolt; and
upon swinging of the swing thumb turn along the arc in a second direction to retract the deadbolt, disengaging the clutch mechanism after a lapse of a period of time to render the swing thumb turn inoperable to move the deadbolt.
